(19) United States
(12) Patent Application Publication
(10) Pub. No.: US 2026/0093550 A1
(43) Pub. Date: Apr. 2, 2026

(54) CONTROL METHOD AND TERMINAL DEVICE

(71) Applicant: Lenovo (Beijing) Limited, Beijing (CN)

(72) Inventor: Xuejin WANG, Beijing (CN)

(21) Appl. No.: 19/333,195

(22) Filed: Sep. 18, 2025

(30) Foreign Application Priority Data
Sep. 30, 2024 (CN) 202411391901.8

(51) Int. Cl. G06F 9/50

(52) U.S. Cl. CPC G06F 9/5044

(57) ABSTRACT

A control method includes: obtaining input data representing a user intent; in response to the input data, converting the input data into a target request including a target action, a target capability, and a target execution device; in response to the conversion, determining, from a capability set, a first capability that satisfies the target capability and a first execution device for the first capability as the target execution device; in response to the target request, responding to the target action with the first capability based on the first execution device to satisfy the user intent; where, in response to the first execution device being a target device among the electronic devices, transmitting, via a connection channel with the target device, a call instruction for invoking the first capability and input content provided to the first capability.

### CROSS-REFERENCE TO RELATED APPLICATION(S)

This application claims priority to Chinese Patent Application No. 2024113919018 filed on Sep. 30, 2024, which is incorporated herein by reference in its entirety.

### FIELD OF THE TECHNOLOGY

The present disclosure relates to a technical field of device interconnection, and in particular to a control method and terminal device.

### BACKGROUND

In certain existing technology, when performing a certain action, a terminal device may use a functional module that provides a corresponding capability. However, there are scenarios where the terminal device does not have the functional module with this capability or the functional module cannot be used, resulting in low reliability of the action being executed.

### SUMMARY

In one aspect, the present disclosure provides a control method. The method includes: obtaining input data representing a user intent; in response to the input data, converting the input data into a target request including a target action, a target capability, and a target execution device; in response to the conversion, determining, from a capability set, a first capability that satisfies the target capability and a first execution device for the first capability as the target execution device; where the capability set includes: a local capability set of a terminal device and a remote capability set of at least one electronic device that satisfies a connection condition with the terminal device; in response to the target request, responding to the target action with the first capability based on the first execution device to satisfy the user intent; where, in response to the first execution device being a target device among the electronic devices, transmitting, via a connection channel with the target device, a call instruction for invoking the first capability and input content provided to the first capability.

In another aspect, the present disclosure provides an electronic device. The device includes: a memory storing computer program instructions; and a processor coupled to the memory and configured to execute the computer program instructions and perform: obtaining input data representing a user intent; in response to the input data, converting the input data into a target request including a target action, a target capability, and a target execution device; in response to the conversion, determining, from a capability set, a first capability that satisfies the target capability and a first execution device for the first capability as the target execution device; where the capability set includes: a local capability set of a terminal device and a remote capability set of at least one electronic device that satisfies a connection condition with the terminal device; in response to the target request, responding to the target action with the first capability based on the first execution device to satisfy the user intent; where, in response to the first execution device being a target device among the electronic devices, transmitting, via a connection channel with the target device, a call instruction for invoking the first capability and input content provided to the first capability.

In yet another aspect, the present disclosure provides a non-transitory computer-readable storage medium storing computer program instructions executable by at least one processor to perform: obtaining input data representing a user intent; in response to the input data, converting the input data into a target request including a target action, a target capability, and a target execution device; in response to the conversion, determining, from a capability set, a first capability that satisfies the target capability and a first execution device for the first capability as the target execution device; where the capability set includes: a local capability set of a terminal device and a remote capability set of at least one electronic device that satisfies a connection condition with the terminal device; in response to the target request, responding to the target action with the first capability based on the first execution device to satisfy the user intent; where, in response to the first execution device being a target device among the electronic devices, transmitting, via a connection channel with the target device, a call instruction for invoking the first capability and input content provided to the first capability.

### BRIEF DESCRIPTION OF THE DRAWINGS

In order to more clearly illustrate the technical solutions of certain embodiments of the present disclosure, the following briefly introduces the drawings for use in the description of certain embodiments. The drawings described below reflect only certain embodiments of the present disclosure. For ordinary technicians in the technical field, other drawings may be obtained based on these drawings without any creative work.

FIG. 1 is a flow chart of a control method according to certain embodiments of the present disclosure;

FIG. 2 is an example diagram of a device interconnection according to certain embodiments of the present disclosure;

FIG. 3 is an example diagram of a mobile phone using a large language model on a server according to certain embodiments of the present disclosure;

FIG. 4 illustrates an example of a mobile phone using a tablet device to project its screen externally, according to certain embodiments of the present disclosure.

FIG. 5 illustrates an example of a mobile phone using a tablet device to project its screen onto a television, according to certain embodiments of the present disclosure.

FIG. 6 illustrates an example of a SC on a mobile phone obtaining capabilities of the mobile phone, according to certain embodiments of the present disclosure.

FIG. 7 illustrates an example of a SC on a tablet transmitting capabilities to a SC on a mobile phone, according to certain embodiments of the present disclosure.

FIG. 8 illustrates an example of a tablet SC transmitting capability status update information to a mobile phone SC in accordance with certain embodiments of the present disclosure.

FIG. 9 illustrates a schematic diagram of a structure of a terminal device provided in accordance with certain embodiments of the present disclosure.

FIG. 10 illustrates an example of establishing interconnection between a mobile phone, a server, and a tablet device via the SC in accordance with certain embodiments of the present disclosure.

FIG. 11 illustrates an example of parsing cross-device tasks and transferring locally inoperable tasks to an executable device in accordance with certain embodiments of the present disclosure.

FIG. 12 illustrates an example of converting speech into an executable task by invoking the voice-to-task capability across devices in certain embodiments of the present disclosure.

FIG. 13 illustrates an interaction sequence diagram for implementing capability collection and interoperability through SC in a device interconnection scenario in certain embodiments of the present disclosure.

FIG. 14 illustrates an interaction sequence diagram for implementing capability invocation through SC in a device interconnection scenario in certain embodiments of the present disclosure.

### DETAILED DESCRIPTION

In view of the accompanying drawings, description is provided below to reflect several technical solutions in certain embodiments of the present disclosure. The embodiments described are only part of the embodiments of the present disclosure, not all of the embodiments. Based on the embodiments described in the present disclosure, other embodiments obtained by ordinary technicians in the technical field without making creative efforts are within the scope of protection of the present disclosure.

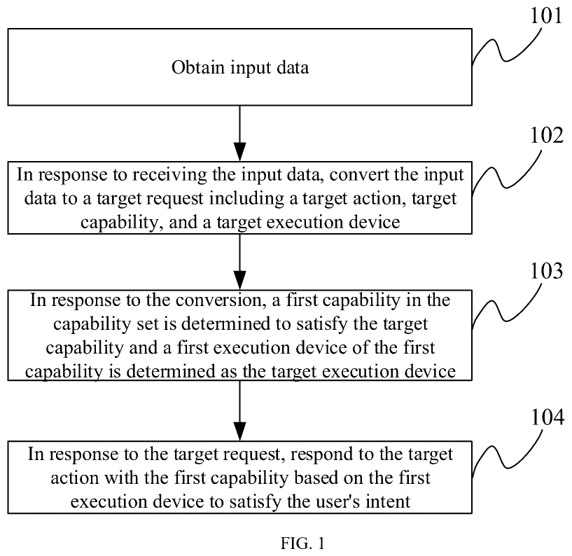

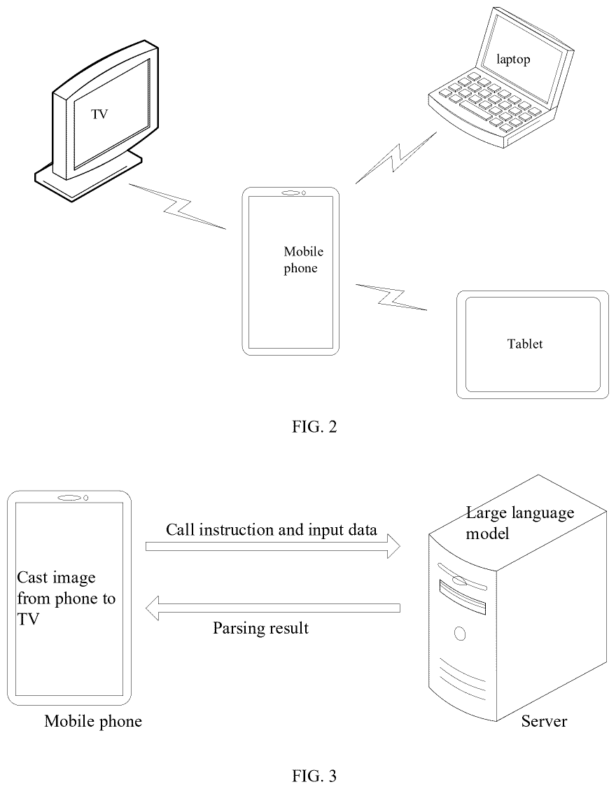

Referring to FIG. 1, which is a flowchart illustrating an implementation of a control method provided in certain embodiments of the present disclosure, the method may be applied to a terminal device that may meet connection conditions with at least one electronic device, such as a mobile phone, a tablet device, etc. For example, as shown in FIG. 2, the terminal device may be a mobile phone, and the electronic device that meets the connection conditions with the terminal device may be another mobile phone, a tablet device, a laptop, a television, or other device. The target function module is deployed on both the terminal device and the electronic device. The target function module may be a hardware module or a software module. The software module may be a system module or a third-party application. The target function module may have one or more capabilities. The target function module may include one or more functional sub-modules, and each functional sub-module provides one capability. The connection condition is the condition for achieving interconnection between the terminal device and the electronic device. Specifically, the super interconnection application SC (SmartConnect) is deployed on the terminal device and the electronic device. The terminal device and the electronic device establish a connection channel through their respective SCs to achieve interconnection and meet the connection conditions. The technical solution in this embodiment is mainly used to improve the reliability of the execution of the action.

In certain embodiments, the method may include one or more of:
Step 101: Obtain input data.

The input data is used to represent user intent.

In certain embodiments, the input data may be obtained through a target application, which may be an artificial intelligence (AI) assistant, such as a voice assistant in a mobile phone. Voice assistants may receive input data, such as text or voice, which represents user intent.

102: In response to receiving the input data, converting the input data to a target request that includes a target action, target capability, and a target execution device.

In certain embodiments, a request template may be preset. This request template includes three fill-in items: target action, target capability, and target execution device. After receiving input data, converting the input data to a target request according to the request template. The target request includes the target action, target capability, and target execution device.

When the terminal device cannot parse the input data, the target action in the target request is the action of parsing the input data, which may be recorded as the first action.

The target capability is the first capability of the action that may execute the first action. The target execution device is a device with the target capability, but the target execution device is not determined.

When the terminal device is capable of parsing the input data, the target action in the target request is the action parsed from the input data, which may be recorded as the first action, such as a text to image action or a screen casting action. The target capability is the first capability that may execute the first action, and the target execution device is a device with the target capability, but the target execution device is not determined. In an implementation, the target capability may be a capability possessed by the terminal device or a capability possessed by a target device in an electronic device, and the target execution device may be either the terminal device or the target device in an electronic device, but the target execution device is not determined.

Step 103: In response to the conversion, a first capability in the capability set is determined to satisfy the target capability and a first execution device of the first capability is determined as the target execution device.

The capability set includes: the local capability set of the terminal device and the remote capability set of each electronic device that meets the connection conditions with the terminal device. The local capability set includes capabilities possessed by the terminal device, and each capability corresponds to a capability description and status information. The capability description conforms to natural language and describes the function achieved by the corresponding capability through natural language description. The capability status information may indicate whether the capability is available and the degree of function achieved by the capability. The remote capability set includes capabilities possessed by each electronic device that meets the connection conditions with the terminal device, and each capability corresponds to a capability description and status information.

After constructing the target request, at least one target execution device in the target request is still uncertain. At this time, the capability required to execute the first action may be determined from the local capability set of the terminal device or the remote energy set of each electronic device. This capability may be recorded as the first capability, and the first capability serves as the target capability in the target request. In addition, the execution device that may call the first capability to execute the first action is also determined. This may be recorded as the first execution device, and the first execution device serves as the target execution device in the target request. Therefore, after determining the first capability and the first execution device, the target action, target capability, and target execution device in the target request are complete.

The local capability set of a terminal device includes the capabilities of each target functional module deployed on the terminal device, while the remote capability set of each electronic device includes the capabilities of each target functional module deployed on the electronic device.

For example, the target request includes: parsing actions, parsing capabilities for executing parsing actions, and executing devices with parsing capabilities, such as servers.

For another example, the target request includes: a text to image action, a text to image capability for executing the text to image action, and an execution device with the text to image capability, such as a local mobile phone.

For another example, the target request includes: a screen casting action, a screen casting capability for executing the screen casting action, and an execution device with the screen casting capability, such as a tablet device.

Step 104: In response to the target request, respond to the target action with the first capability based on the first execution device to satisfy the user's intent.

In response to the first execution device being a target device in an electronic device, the first execution device transmits a call instruction for invoking the first capability and input content provided to the first capability via a connection channel with the target device.

In response to the first device being a terminal device, in response to the call instruction for invoking the first capability, the first capability is provided with input content, so that the functional submodule implementing the first capability on the terminal device processes the input content to produce an output result.

The output result may be provided to the user as feedback information about the input data, or simply recorded.

For example, a mobile phone obtains input data “cast the image on the mobile phone to the TV” through a voice assistant. In response to the input data, the mobile phone cannot parse the input data. At this time, the target action in the target request may be determined as the action of parsing the input data. Then, the parsing capability for executing the parsing action and the execution device with parsing capability, such as a server, are determined in the capability set. In response to this target request, the mobile phone sends a call instruction to call the parsing capability and the input content provided to the parsing capability through the connection channel between the mobile phone and the server. The input content is the input data “cast the image on the mobile phone to the TV”. Based on this, the server responds to the call instruction and calls the parsing capability to process the received input content. For example, the server inputs the input data “cast the image on the mobile phone to the TV” into a large language model with parsing capabilities, and the large language model outputs the parsing result, for example, the output result, and returns the parsing result to the mobile phone through the connection channel, as shown in FIG. 3. In this way, data parsing may be achieved on a mobile phone without parsing capabilities.

For example, a mobile phone receives input data through a voice assistant, such as “Generate an image of a dog with big eyes.” In response to this input data, the phone may parse the input data and determine that the target action in the target request is a text to image action. It then identifies the text to image capability and the device with the text to image capability, such as the phone itself, that may execute the text to image action from the capability set. In response to the target request, the phone inputs the input content “Generate an image of a dog with big eyes” into the text to image model deployed on the phone. The text to image model then outputs an image of a “dog with big eyes,” which is the output result, and the image of a “dog with big eyes” is displayed to the user.

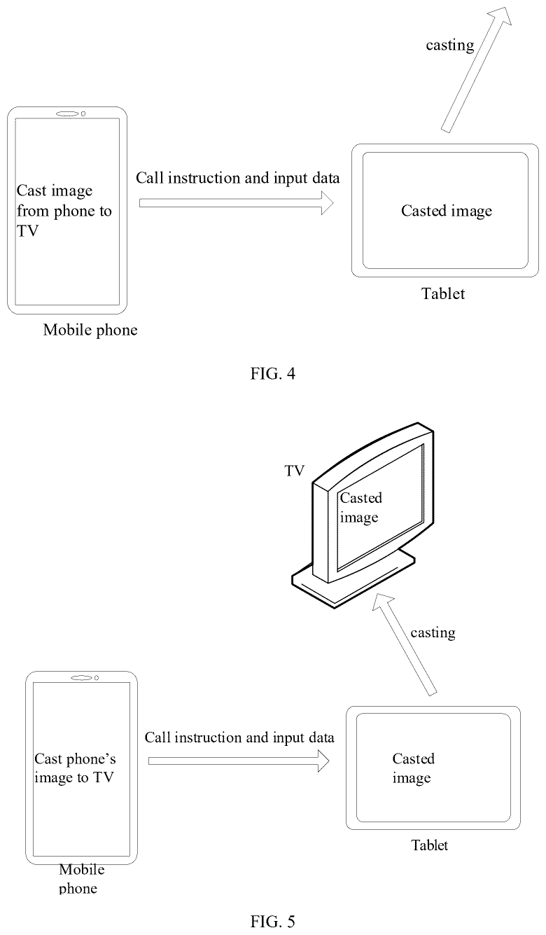

For another example, the mobile phone obtains input data “cast the image on the mobile phone to the TV” through the voice assistant. In response to the input data, the mobile phone may parse the input data. At this time, it may be determined that the target action in the target request is the screen casting action. Then, the screen casting capability for executing the screen casting action and the execution device with screen casting capability, such as a tablet device, are determined from the capability set. In response to the target request, the mobile phone sends a call instruction for calling the screen casting capability and the cast image provided to the screen casting capability to the tablet device through the connection channel between the mobile phone and the tablet device. Based on this, the tablet device responds to the call instruction and calls the screen casting capability. For example, the tablet device casts the received cast image through the deployed screen casting application, as shown in FIG. 4. As a result, the screen casting output of the cast image may be achieved on a mobile phone without screen casting capability.

It may be seen from the above technical solution that in a control method adopted in certain embodiments of the present disclosure, when executing a target action on a terminal device, the input data representing the user's intention is converted into a target request including the target action, and the first capability in the target request and the first execution device of the first capability are determined from the capability set, and then the target action is responded to with the first capability based on the first execution device. The first capability here may be a capability possessed by the terminal device, or a capability possessed by an electronic device that satisfies a connection relationship with the terminal device. Therefore, the first execution device may be both a terminal device and a target device in the electronic device. In this way, when the terminal device cannot provide the first capability, then the first execution device is the target device in the electronic device. In response to the first execution device being the target device, then a call instruction and input content may be sent via the connection channel with the target device. The target device then uses the call instruction to invoke the first capability to process the input content, thereby responding to the target action on the target device to satisfy the user's intent. Thus, in certain embodiments, even when the terminal device cannot execute the target action, the target action may still be executed via a target device that meets the connection conditions with the terminal device, thereby improving the reliability of the target action execution.

In one implementation, determining from the capability set that the first capability satisfies the target capability and the first execution device of the first capability as the target execution device in 103 may be accomplished as follows:
Based on the local capability set prioritized over the remote capability set, determining from the capability set that the first capability satisfies the target capability and the first execution device of the first capability as the target execution device.

In certain embodiments, the first capability that satisfies the target capability and the first execution device of the first capability may be determined from the local capability set as the target execution device; when the first capability that satisfies the target capability cannot be determined from the local capability set, then the first capability that satisfies the target capability and the first execution device of the first capability may be determined from the remote capability set as the target execution device.

In one scenario, the terminal device cannot parse the input data. In this scenario, when converting the input data into the target request at step 102, the description of the first action and the description of the first capability may be obtained. The first action is the target action. The description of the first action is the description of the parsing action, and the description of the first capability is the description of the parsing capability.

At step 103, because the terminal device cannot parse the input data, the terminal device does not have the parsing capability, and there is no parsing capability in the local capability set. At this time, according to the description of the first action and the description of the first capability, the parsing capability and the execution device with parsing capability may be determined from the remote capability set. Thus, the target request is obtained: parsing action, parsing capability for executing the parsing action, and execution device with parsing capability, such as a server.

In another scenario, the terminal device is capable of parsing the input data. In this scenario, when converting the input data into the target request at step 102, the input data may be processed based on the terminal device's natural language understanding model to obtain the description of the first action and the description of the first capability.

For example, the description of the first action may be the description of the text to image action, and the description of the first capability may be the description of the text to image capability. In another example, the description of the first action may be the description of the screen casting action, and the description of the first capability may be the description of the screen casting capability.

At step 103, the first capability that satisfies the target capability and the first execution device of the first capability may be determined from the local capability set as the target execution device; when the first capability that satisfies the target capability cannot be determined from the local capability set, then the first capability and the execution device with the first capability are determined from the remote capability set, thereby obtaining the target request: the first action, the first capability for executing the first action, and the execution device with the first capability, such as a mobile phone with text and image capabilities or a tablet device with screen casting capabilities.

Based on the above implementation, the execution of the first action not only relies on the first execution device but also on other devices. For example, when the first action is screen casting, screen casting depends on both the source device and the destination device.

In certain embodiments, when converting step 102 to a target request, it also includes obtaining the associated devices for the target execution device to execute the target action.

Therefore, after determining the first capability and the first execution device at step 103, the second execution device required by the first execution device to perform the first action may also be determined as an associated device. The resulting target request includes not only the first action, the first capability, and the first execution device, but also the second execution device associated with the first execution device to perform the first task.

At step 103, the second execution device may be determined from other devices connected to the first execution device.

For example, the mobile phone uses a natural language understanding model to process the action “cast the image on the mobile phone to the TV” to determine the description of the first action in the target request “casting action” and the description of the first capability “casting the image on the mobile phone to the TV”. Based on this, at step 103, the first capability of “casting the image on the mobile phone to the TV” is determined from the remote capability set, and the first execution device with “casting the image on the mobile phone to the TV” such as a tablet device is also determined. The second execution device such as “TV” that may serve as the casting destination may also be determined from the air conditioner, washing machine and TV connected to the tablet device. Based on this, in response to the target request, the mobile phone sends the cast image and the call instruction for calling the cast capability to the tablet device through the connection channel between the mobile phone and the tablet device. The tablet device casts the cast image to the TV according to the call instruction, as shown in FIG. 5.

In one implementation, the capabilities in the local capability set may be obtained by:
At least one capability of the terminal device is obtained from the terminal device's system registry. The target functional module in the terminal device then registers its capabilities with the system registry.

For example, capabilities of each hardware and software module on a phone are registered into the system registry when it is installed or started. Furthermore, each hardware and software module on the phone updates its capabilities to the system registry when they are upgraded or updated. Based on this, any target functional module on the phone, such as an SC or AI application, may obtain the phone's capabilities from the system registry. These capabilities constitute the local capability set.

In another implementation, the capabilities in the local capability set may be obtained by:
Any target functional module in the terminal device may query any other target functional module for its declared capabilities. This allows any target functional module on the terminal device to obtain capabilities possessed by the terminal device.

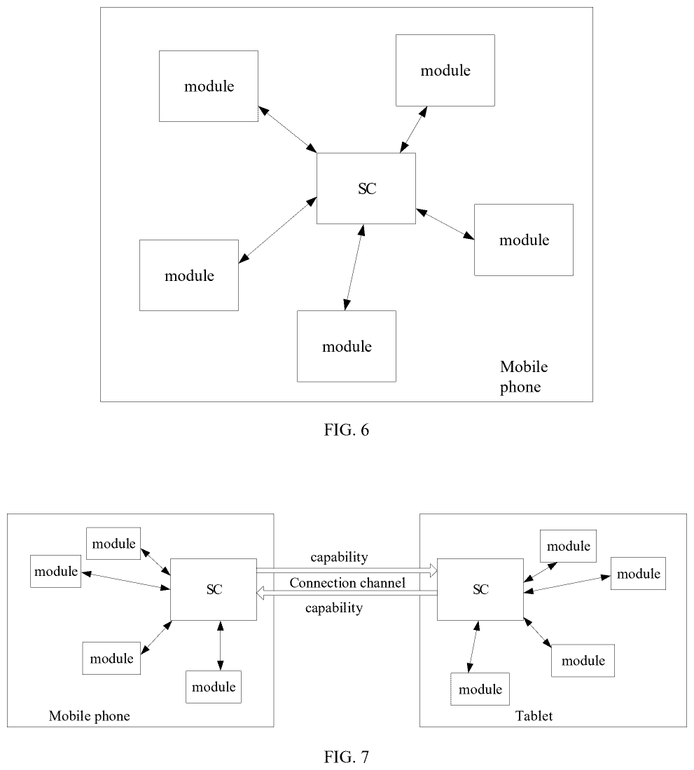

For example, any hardware module or software module on a mobile phone may query any other software module or hardware module for its declared capabilities, as shown in FIG. 6. Thus, any hardware module or software module on a mobile phone, such as an SC or AI application, may obtain capabilities of the mobile phone.

In one implementation, the capabilities in the remote capability set may be obtained by:
Receiving the capabilities transmitted by each electronic device through the connection channel between the terminal device and each electronic device.

The capabilities transmitted by the electronic device are obtained by querying the capabilities of any target functional module in the electronic device, or by obtaining the capabilities from the electronic device's system registry.

The method by which an electronic device obtains its own capabilities may be similar to the method by which a terminal device obtains its local capabilities set, and will not be further elaborated here. Based on this, any target functional module on an electronic device, such as a SC, may obtain all the capabilities of the electronic device.

A terminal device may receive the capabilities transmitted by the SC in the electronic device through a connection channel. The capabilities transmitted by the SC constitute the electronic device's local capabilities set, which is the remote capabilities set for the terminal device.

For example, a connection channel is established between the tablet device and the mobile phone through their respective SCs. Any hardware module or software module on the tablet device, such as the SC, may obtain the capabilities of the tablet device from the system registry of the tablet device, or the SC may query the capabilities declared by any other software module or hardware module on the tablet device, as shown in FIG. 7. Thus, any hardware module or software module on the tablet device, such as the SC, may obtain the capabilities of the tablet device. These capabilities are sent to the SC on the mobile phone by the SC of the tablet device through the connection channel. These capabilities constitute a remote capability set.

Any hardware module or software module on the mobile phone, such as SC, may obtain the capabilities of the mobile phone from the system registry of the mobile phone, or the SC may query the capabilities declared by any other software module or hardware module on the mobile phone, as shown in FIG. 7. In this way, any hardware module or software module on the mobile phone, such as SC, may obtain the capabilities of the mobile phone. These capabilities are sent by the SC of the mobile phone to the SC on the tablet device through the connection channel. These capabilities constitute the remote capability set.

In certain embodiments, status update information for any capability in the remote capability set is obtained via the connection channel, and the status information of the corresponding capability in the remote capability set is updated based on the status update information.

In certain embodiments, any target functional module on the electronic device queries the capabilities declared by any other target functional module in real time or periodically. Thus, each target functional module, such as the SC, may detect the status update information of each capability, such as capability upgrades or capability replacements. The electronic device may send the status update information of the capabilities that have changed to the terminal device via the connection channel. The terminal device may update the status information of the corresponding capability in the remote capability set based on the status update information.

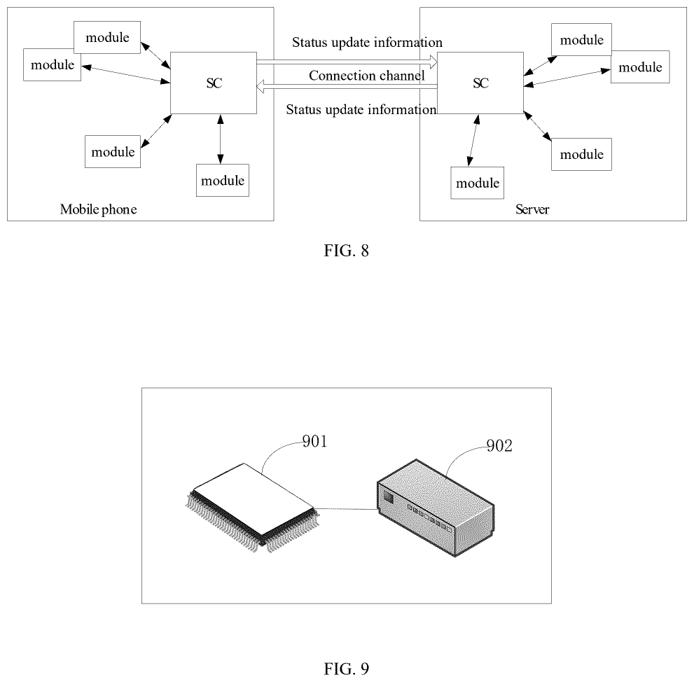

For example, when the SC on the server detects that a capability upgrade is available, it sends the status update information of the capability to the SC on the mobile phone through the connection channel established with the SC on the mobile phone. The SC on the mobile phone may update the status information of the corresponding capability in the remote capability set on the mobile phone according to the status update information of the capability, as shown in FIG. 8.

When the SC on the mobile phone detects that it has a capability to be upgraded, it sends the status update information of the capability to the SC on the server through the connection channel established with the SC on the server. The SC on the server may update the status information of the corresponding capability in the remote capability set on the server according to the status update information of the capability, as shown in FIG. 8.

In certain embodiments, at step 104, where the first execution device responds to the target action using the first capability, may be implemented as follows:
In response to the first execution device being a terminal device, the input content may be sent to the first capability via the connected first call service that invokes the first capability. Then, the output result of the first capability processing the input content may be obtained via the first call service.

For example, any software module or hardware module on a mobile phone may query the capabilities declared by any other software module or hardware module and connect to the calling service that calls these capabilities. Based on this, when any software module or hardware module on the mobile phone needs to call a first capability, such as the text to image capability, it may input the input content “generate an image of a dog with big eyes” into the text to image model deployed on the mobile phone through the first call service, such as the call service that calls the text to image capability. The text to image model outputs the image of the “dog with big eyes”, which is the output result. Then, the image of the “dog with big eyes” is obtained by calling the call service of the text to image capability, and then the image of the “dog with big eyes” is output to the user.

In certain embodiments, at step 104, when the first execution device responds to the target action with the first capability, the step may be accomplished as follows:
In response to the first execution device being the target device, the call instruction and input content may be sent to the target device via a connection channel, and then the output result returned by the target device may be received via the connection channel. The input content may be input data, or input parameters that enable the first capability.

The target device sends input content to the first capability through the first call service that calls the first capability to which it is connected; and then obtains, through the first call service, an output result obtained by the first capability processing the input content.

For example, any software module or hardware module on a mobile phone may query the capabilities declared by any other software module or hardware module and connect to the call service that calls these capabilities. Any software module or hardware module on a mobile phone may query the capabilities declared by any other software module or hardware module and connect to the call service that calls these capabilities. The mobile phone and the server may achieve capability intercommunication through the connection channel. Based on this, when any software module or hardware module on the mobile phone needs to call the first capability, such as the parsing capability, the mobile phone sends a call instruction for calling the parsing capability and the input content provided to the parsing capability to the server through the connection channel between the mobile phone and the server. The input content may be input data. Afterwards, any module on the server that receives the call instruction and input content may call the first call service connected, such as the call service for calling the parsing capability, to input the input content “cast the image on the mobile phone to the TV” into the large language model with parsing capability. The large language model outputs the parsing result, for example, the output result. The parsing result is then obtained by calling the call service for calling the parsing capability, and the parsing result is returned to the mobile phone through the connection channel. In this way, data parsing is achieved on a mobile phone without parsing capability.

FIG. 9 is a schematic diagram of the structure of a terminal device provided in certain embodiments of the present disclosure. The terminal device may include:
Memory 901, configured to store a computer program and data generated by the execution of the computer program;
Processor 902, configured to execute the computer program to implement:
Obtaining input data representing a user's intent;
In response to the input data, converting the input data into a target request includes a target action, a target capability, and a target execution device;
In response to the conversion, determining, from a capability set, a first capability that satisfies the target capability and a first execution device of the first capability as the target execution device;
The capability set includes: the local capability set of the terminal device and the remote capability set of at least one electronic device that satisfies the connection conditions with the terminal device;
In response to the target request, the first execution device responds to the target action using the first capability to satisfy the user's intent;
In response to the first execution device being a target device in the electronic device, a call instruction for calling the first capability and input content provided to the first capability are transmitted via a connection channel with the target device.

The processor on the terminal device may deploy at least one target functional module, such as an SC or AI application.

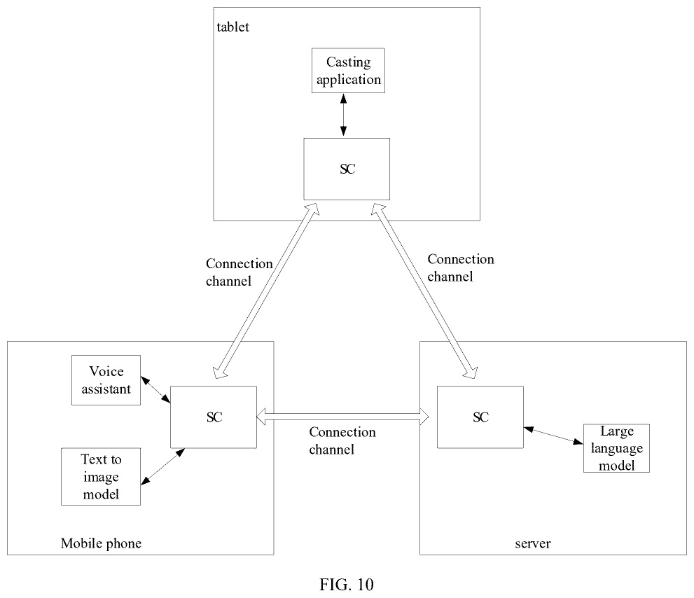

For example, as shown in FIG. 10, a mobile phone is deployed with modules such as a voice assistant, SC, and a text to image model. The voice assistant has the ability to collect voice or text, the SC has the ability of super interconnection, and the text to image model has the text to image capability. The tablet device is deployed with SC and a screen casting application, which has the screen casting capability. The server is deployed with SC and a large language model, which has the ability to parse data. The mobile phone and tablet device establish a connection channel through their respective SCs, the mobile phone and the server establish a connection channel through their respective SCs, and the server and the tablet device establish a connection channel through their respective SCs. The SC on the mobile phone may collect the local capability set, the SC on the server may collect the local capability set, and the SC on the tablet device may collect the local capability set. The mobile phone, server and tablet device communicate with each other through the connection channel established by the SC. The local capabilities of the server and tablet are then transferred to the phone as its remote capabilities.

The local capabilities of the phone and tablet are then transferred to the server as its remote capabilities. The local capabilities of the server and phone are then transferred to the tablet as its remote capabilities. The phone, server, and tablet may each use their own local capabilities, or they may use each other's remote capabilities through the connection channel.

Based on this, the mobile phone may obtain input data “cast the image on the mobile phone to the TV” through the voice assistant. In response to the input data, the mobile phone cannot parse the input data. At this time, the target action in the target request may be determined to be the action of parsing the input data. Then, the parsing capability for executing the parsing action and the execution device with parsing capability, such as the server, are determined in the capability set. In response to the target request, the mobile phone establishes a connection channel with the server through the SC. A call instruction for calling the parsing capability and input content provided to the parsing capability are sent. The input content may be input data. Based on this, the server responds to the call instruction and calls the parsing capability to process the received input content. For example, the server inputs the input data “cast the image on the mobile phone to the TV” into the large language model with parsing capability. The large language model outputs the parsing result, for example, the output result.

The parsing result is returned to the mobile phone through the connection channel established by the SC. In this way, data parsing is achieved on the mobile phone without parsing capability.

For example, a mobile phone receives input data through a voice assistant, such as “Generate an image of a dog with big eyes.” In response to this input data, the phone may parse the input data and determine that the target action in the target request is a text to image action. It then identifies the text to image capability and the device with the text to image capability, such as the phone itself, that may execute the text to image action from the capability set. In response to the target request, the phone inputs the input content “Generate an image of a dog with big eyes” into the text to image model deployed on the phone. The text to image model then outputs an image of a “dog with big eyes,” which is the output result, and the image of a “dog with big eyes” is displayed to the user.

For another example, the mobile phone obtains input data “cast the image on the mobile phone to the TV” through the voice assistant. In response to the input data, the mobile phone may parse the input data. At this time, it may be determined that the target action in the target request is the screen casting action. Then, the screen casting capability for executing the screen casting action and the execution device with screen casting capability, such as a tablet device, are determined in the capability set. In response to the target request, the mobile phone sends a call instruction for calling the screen casting capability and the cast image provided to the screen casting capability to the tablet device through the connection channel established with the tablet device through the SC. Based on this, the tablet device responds to the call instruction and calls the screen casting capability. For example, the tablet device casts the received cast image to the TV, thereby realizing the cast output of the cast image on a mobile phone without the screen casting capability.

It may be seen from the above technical solution that in a terminal device adopted by certain embodiments of the present disclosure, when executing a target action on the terminal device, the input data representing the user's intention is converted into a target request including the target action, and the first capability in the target request and the first execution device of the first capability are determined from the capability set, and then the target action is responded to with the first capability based on the first execution device. The first capability here may be a capability possessed by the terminal device, or a capability possessed by an electronic device that satisfies a connection relationship with the terminal device. Therefore, the first execution device may be either a terminal device or a target device in the electronic device. When the terminal device cannot provide the first capability, the first execution device is the target device in the electronic device. In response to the first execution device being the target device, the call instruction and input content may be sent through the connection channel with the target device, so that the target device may invoke the first capability through the call instruction to process the input content, thereby responding to the target action on the target device to meet the user's intention. As may be seen, even when the terminal device cannot execute the target action, the target action may still be executed through the target device that satisfies the connection conditions with the terminal device, thereby improving the reliability of the execution of the target action.

Taking the device interconnection scenario as an example, the following illustrates the technical solution according to certain embodiments of the present disclosure:

In the era of device interconnection, users are no longer restricted to performing tasks on a single device. Therefore, when there are multiple devices, operations may primarily be performed on a single primary device. However, instruction issued must be parsed. When a local personal computer (PC) is found to be capable of processing them, the PC will process them. However, there may be scenarios where instructions issued on the PC require processing on a phone or tablet. For example, a user issues an instruction on the PC and enters “Please help me cast my phone screen to my tablet” in the PC input box.

In certain embodiments, the present disclosure provides the following solution:
First, deploy SCs on PCs, phones, and tablets. SCs determine tasks based on the “From & To” parameters.

For example, a user enters “Please enable screen casting on my phone to my tablet” on a PC. The PC parses the input and detects the task is to cast the screen from phone to tablet. At this point, the PC locates the execution device. If neither of the From/To devices is a local device, it searches for the task on the paired device. It then searches for the corresponding task on the paired device and executes the task.

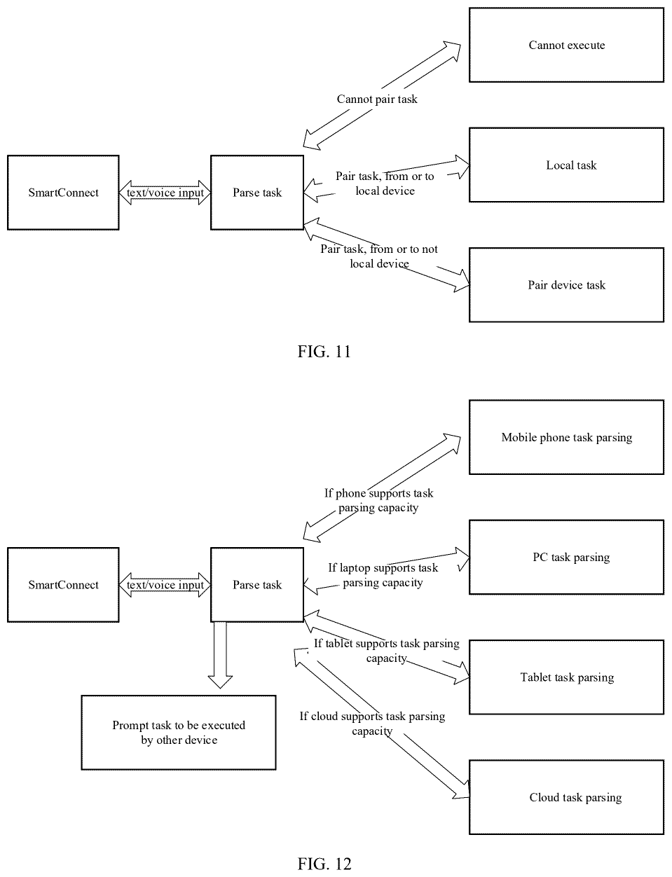

FIG. 11 is an example diagram for parsing cross-device tasks and transferring local non-executable tasks to executable devices, the PC performs task parsing on input data such as text input or voice input related to the task, and after obtaining the target request, performs task pairing, that is, calls capabilities. When the PC cannot pair the task, the PC cannot execute it; when the PC may pair the task, where from or to is the local PC, it is a local task, and the task may be executed on the PC; when the PC may pair the task, but from or to is not the local PC, the PC needs to pair the task device, and the paired task device will execute the task. The task may be transferred to the paired task device through the super interconnection application.

Taking the device interconnection scenario as an example, the following illustrates the technical solution according to certain embodiments of the present disclosure:

In the era of device interconnection, even after the SC completes device pairing and establishes a connection channel, users still rely on manual clicks and selections to access cross-device functions, failing to achieve truly automated interconnection. For example, to cast a mobile application, a user may need to open the application list, swipe to find the application, and then click to open it.

In light of this, certain embodiments of the present disclosure provide the following solution:
The SC in the mobile phone provides an input box that accepts voice or text input and converts natural language into action instructions, thereby enabling one-touch opening tasks. Furthermore, due to the SC's device pairing feature, the voice-to-action instruction capability is no longer limited to triggering the device itself; all paired devices with this capability may complete the task.

A user has an AI-powered PC, a regular phone, and a regular tablet. “Regular” here means it doesn't support AI capabilities or Large Language Models (LLMs). Based on this, the user may trigger a voice instruction on their regular phone: “Cast my WeChat screen from my phone to my computer.” Upon receiving this instruction, the phone dynamically queries connected devices and local capabilities to identify which devices support this parsing function. The instruction is then sent to the AI-powered PC for parsing, resulting in the task and parameters, such as casting the screen from the phone to the PC. This allows automatic screen casting in certain embodiments of the present disclosure.

As shown in FIG. 12, an example diagram of converting speech into an executable task by invoking the voice-to-task capability across devices is shown. The phone receives input data, such as text input or voice input, related to the task. When the phone supports task parsing, it performs task parsing on the input data. When the PC supports task parsing, the phone sends the input data to the PC via SC, which performs task parsing. Furthermore, the phone may prompt the PC to perform task parsing. When the tablet supports task parsing, the phone sends the input data to the tablet via SC, which performs task parsing. Furthermore, the phone may prompt the tablet to perform task parsing. When the cloud server supports task parsing, the phone sends the input data to the cloud server via SC, which performs task parsing. Furthermore, the phone may prompt the cloud server to perform task parsing.

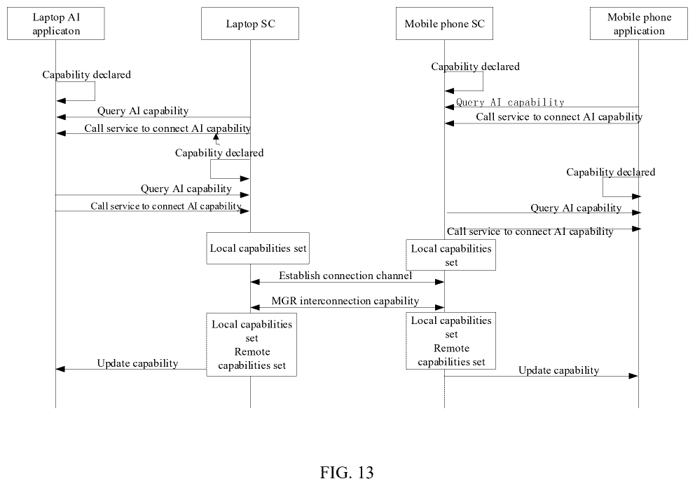

FIG. 13 shows an interactive sequence diagram for capability collection and intercommunication through SC in a device interconnection scenario. In this diagram, a laptop is deployed with AI applications and other functional modules that have AI capabilities, such as the text to image capability, while a mobile phone is deployed with applications and other functional modules that require text to image capabilities. SCs are deployed on both the laptop and the mobile phone. The process may be as follows:

First, each application deployed on a laptop declares its own capabilities, such as the AI graphics capability declared by an AI application or the super interconnection capability declared by the SC. Each application on the laptop may query the capabilities declared by other applications and connect to the call service for the queried capabilities. For example, the SC on the laptop may query the text to image capability declared by an AI application and connect to the call service for that capability. As a result, each functional module on the laptop may have a local set of capabilities for the laptop.

Each application deployed on a mobile phone declares its own capabilities, such as the AI image generation capability declared by an AI application or the super interconnection capability declared by the SC. Each application on a phone may query the capabilities declared by other applications and connect to the service that invokes those capabilities. For example, other applications on a phone may query the super interconnection capability declared by the SC and connect to the service that invokes that capability. As a result, each functional module on a phone may include a local set of capabilities.

Secondly, the laptop's SC may manage the capabilities it has queried through the SmartConnect Capability Manager (MGR) and save them to the capability list; the mobile phone's SC may manage the capabilities it has queried through the MGR and save them to the capability list. Moreover, the laptop and mobile phone may establish a private connection channel through their respective SCs, and communicate the capabilities in their respective MGR's capability lists to each other through the connection channel. As a result, the capability list of the MGR of the SC on the laptop includes the capabilities of each application on the mobile phone, that is, the remote capability set of the laptop, and the capability list of the MGR of the SC on the mobile phone includes the capabilities of each application on the laptop, such as the AI image generation capability, that is, the remote capability set of the mobile phone.

In addition, the SCs on the laptop and phone may receive status updates from each other and update other local applications about the other's capabilities in real time. For example, when the laptop's AI image generation capability changes, the SC on the phone may obtain the new capabilities through the connection channel and update the application that is previously connected to the AI image generation service.

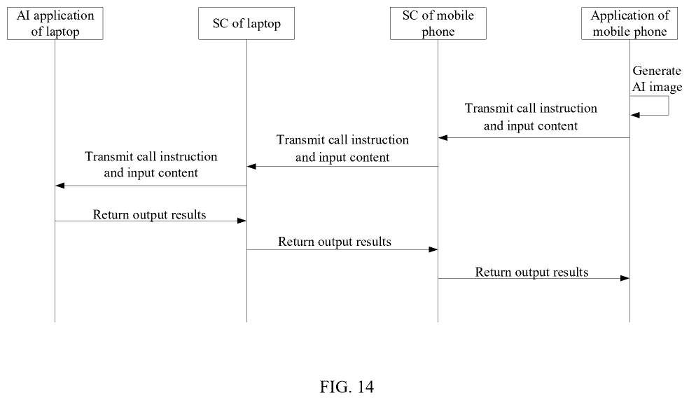

FIG. 14 is an interactive sequence diagram for implementing capability calls through SC in a device interconnection scenario. The application on the mobile phone receives input data representing the need for AI image generation, such as “generate a dog image”, and then first queries whether there is AI image generation capability in the local capability set. If so, the input data is provided to the AI image generation capability through the call service connected to the mobile phone application. After the AI image generation capability generates the image, the image is returned to the mobile phone application; when there is no AI image generation capability in the local capability set, then the execution device with AI image generation capability, such as a laptop, is queried in the remote capability set. Based on this, the call instruction pointing to the AI image generation capability and the input content “generate a dog image” are sent to the SC on the mobile phone. The SC on the mobile phone sends the call instruction and input content of the AI image generation capability to the SC on the laptop through the connection channel. The SC on the laptop calls the AI image generation capability in the AI application on the laptop by calling the service. For example, by calling the service, the call instruction and input content are given to the AI application, and the AI application generates an image. The AI application returns the generated image, that is, the output result, to the SC on the laptop through the callback function. The SC on the laptop sends the output result to the SC on the mobile phone through the connection channel. The SC on the mobile phone returns the output result to the application on the mobile phone, thereby realizing the AI image generation capability of the laptop on the application of the mobile phone.

The various embodiments are described, with each embodiment focusing on the differences from other embodiments. Reference may be made to the common and similar parts between the various embodiments. For the devices disclosed in certain embodiments, since they correspond to the methods disclosed in certain other embodiments, the description is relatively simple, and the relevant parts may be referred to the method description.

Units and algorithm steps of each example described in conjunction with the embodiments disclosed herein may be implemented in electronic hardware, computer software, or a combination of the two. In order to clearly illustrate the interchangeability of hardware and software, the above description has generally described the components and steps of each example according to their functions. Whether these functions are performed in hardware or software depends on the implementation and design constraints of the technical solution.

Professionals and technicians may use different methods to implement the described functions, but such implementation should not be considered beyond the scope of the present disclosure.

Methods or algorithms described in conjunction with the embodiments disclosed herein may be implemented directly using hardware, a software module executed by a processor, or a combination of the two. The software module may be placed in random access memory (RAM), internal memory, read-only memory (ROM), electrically programmable ROM, electrically erasable programmable ROM, registers, a hard disk, a removable disk, a CD-ROM, or any other suitable form of storage medium.

The above description of the disclosed embodiments is intended to enable one skilled in the technical field to implement or use the present disclosure. Various modifications to these embodiments are readily apparent to one skilled in the technical field, and the general principles defined herein may be implemented in other embodiments without departing from the spirit or scope of the present disclosure. Therefore, the present disclosure is not limited to the embodiments shown herein, but is intended to conform to the widest scope consistent with the principles and novel features disclosed herein.

What is claimed is:

1. A control method, comprising:
obtaining input data representing a user intent;
in response to the input data, converting the input data into a target request including a target action, a target capability, and a target execution device;
in response to the conversion, determining, from a capability set, a first capability that satisfies the target capability and a first execution device for the first capability as the target execution device;
wherein, the capability set includes: a local capability set of a terminal device and a remote capability set of at least one electronic device that satisfies a connection condition with the terminal device;
in response to the target request, responding to the target action with the first capability based on the first execution device to satisfy the user intent;
wherein, in response to the first execution device being a target device among the electronic devices, transmitting, via a connection channel with the target device, a call instruction for invoking the first capability and input content provided to the first capability.

2. The method of claim 1, wherein determining, from the capability set, the first capability and the first execution device includes:
prioritizing the local capability set over the remote capability set; and
determining, from the capability set, the first capability that satisfies the target capability and the first execution device for the first capability as the target execution device.

3. The method of claim 1, wherein converting into the target request includes:
obtaining a description of a first action and a description of the first capability.

4. The method of claim 1, wherein converting into the target request includes:
processing the input data based on a natural language understanding model to obtain a description of a first action and a description of the first capability.

5. The method of claim 4, wherein converting into the target request includes:
obtaining associated devices of the target execution device for executing the target action.

6. The method of claim 1, wherein capabilities in the local capability set are obtained by:
obtaining at least one capability possessed by the terminal device from a system registry of the terminal device; a target functional module in the terminal device registering capabilities with the system registry; or
utilizing any target functional module in the terminal device to query any other target functional module for its declared capabilities.

7. The method of claim 1, wherein capabilities in the remote capability set are obtained by:
receiving, via the connection channel, capabilities transmitted by the electronic device,
wherein the capabilities transmitted by the electronic device are obtained by querying capabilities of any target functional module in the electronic device, or by obtaining capabilities transmitted by the electronic device from a system registry of the electronic device.

8. The method of claim 7, further comprising:
obtaining, via the connection channel, status update information for any capability in the remote capability set;
updating, based on the status update information, status information of the corresponding capability in the remote capability set.

9. The method of claim 1, wherein responding to the target action with the first capability includes:
in response to the first execution device being the target device, transmitting the call instruction and the input content to the target device via the connection channel, wherein the target device transmits the input content to the first capability via a connected first call service that calls the first capability, and obtains, via the first call service, an output result of the first capability processing the input content; and
receiving the output result returned by the target device via the connection channel.

10. An electronic device, comprising: a memory storing computer program instructions; and
a processor coupled to the memory and configured to execute the computer program instructions and perform:
obtaining input data representing a user intent;
in response to the input data, converting the input data into a target request including a target action, a target capability, and a target execution device;
in response to the conversion, determining, from a capability set, a first capability that satisfies the target capability and a first execution device for the first capability as the target execution device;
wherein, the capability set includes: a local capability set of a terminal device and a remote capability set of at least one electronic device that satisfies a connection condition with the terminal device;
in response to the target request, responding to the target action with the first capability based on the first execution device to satisfy the user intent;
wherein, in response to the first execution device being a target device among the electronic devices, transmitting, via a connection channel with the target device, a call instruction for invoking the first capability and input content provided to the first capability.

11. The electronic device of claim 10, wherein determining, from the capability set, the first capability and the first execution device includes:
prioritizing the local capability set over the remote capability set; and
determining, from the capability set, the first capability that satisfies the target capability and the first execution device for the first capability as the target execution device.

12. The electronic device of claim 10, wherein converting into the target request includes:
obtaining a description of a first action and a description of the first capability.

13. The electronic device of claim 10, wherein converting into the target request includes:
processing the input data based on a natural language understanding model to obtain a description of a first action and a description of the first capability.

14. The electronic device of claim 13, wherein converting into the target request includes:
obtaining associated devices of the target execution device for executing the target action.

15. The electronic device of claim 10, wherein capabilities in the local capability set are obtained by:
obtaining at least one capability possessed by the terminal device from a system registry of the terminal device; a target functional module in the terminal device registering capabilities with the system registry; or
utilizing any target functional module in the terminal device to query any other target functional module for its declared capabilities.

16. The electronic device of claim 10, wherein capabilities in the remote capability set are obtained by:
receiving, via the connection channel, capabilities transmitted by the electronic device,
wherein the capabilities transmitted by the electronic device are obtained by querying capabilities of any target functional module in the electronic device, or by obtaining capabilities transmitted by the electronic device from a system registry of the electronic device.

17. The electronic device of claim 16, wherein the processor is further configured to perform:
obtaining, via the connection channel, status update information for any capability in the remote capability set;
updating, based on the status update information, status information of the corresponding capability in the remote capability set.

18. The electronic device of claim 10, wherein responding to the target action with the first capability includes:
In response to the first execution device being the target device, transmitting the call instruction and the input content to the target device via the connection channel, wherein the target device transmits the input content to the first capability via a connected first call service that calls the first capability, and obtains, via the first call service, an output result of the first capability processing the input content; and
receiving the output result returned by the target device via the connection channel.

19. A non-transitory computer-readable storage medium storing computer program instructions executable by at least one processor to perform:
obtaining input data representing a user intent;
in response to the input data, converting the input data into a target request including a target action, a target capability, and a target execution device;
in response to the conversion, determining, from a capability set, a first capability that satisfies the target capability and a first execution device for the first capability as the target execution device;
wherein, the capability set includes: a local capability set of a terminal device and a remote capability set of at least one electronic device that satisfies a connection condition with the terminal device;
in response to the target request, responding to the target action with the first capability based on the first execution device to satisfy the user intent;
wherein, in response to the first execution device being a target device among the electronic devices, transmitting, via a connection channel with the target device, a call instruction for invoking the first capability and input content provided to the first capability.

20. The non-transitory computer-readable storage medium of claim 19, wherein determining, from the capability set, the first capability and the first execution device includes:
prioritizing the local capability set over the remote capability set; and
determining, from the capability set, the first capability that satisfies the target capability and the first execution device for the first capability as the target execution device.
